(19) United States
(12) Patent Application Publication
(10) Pub. No.: US 2025/0084821 A1
(43) Pub. Date: Mar. 13, 2025

(54) POWER GENERATION COMPLEMENTARY SYSTEM FOR TIDAL RANGE POWER GENERATION AND CONSTRUCTION THEREOF

(71) Applicant: Ming-Feng Cheng, Taipei City (TW)

(72) Inventor: Ming-Feng Cheng, Taipei City (TW)

(21) Appl. No.: 18/633,776

(22) Filed: Apr. 12, 2024

(30) Foreign Application Priority Data
Sep. 11, 2023 (TW) 112134533

(51) Int. Cl. F03B 13/26

(52) U.S. Cl. CPC F03B 13/268; F03B 13/26

(57) ABSTRACT

A power generation complementary system for tidal range power generation and construction, which provides a bay construction tidal range power generation facility to carry out reciprocal and complementary power generation in response to the changing high and low tide levels at tidal time curve turning points, to produce stable power output. The system is constructed with a reserve weir pool facing the direction of incoming ocean tidal energy. The reserve weir pool is divided into a left pool area and a right pool area, which are respectively equipped with an energy conversion equipment associated therewith. According to the state of a tidal time curve, mutually dependent control devices relay an instruction to sequentially handover operation from one conversion equipment to the other conversion equipment, thereby enabling the system to receive quantities of energy and carry out complementary power generation at the appropriate times.

### BACKGROUND OF THE INVENTION

### (a) Field of the Invention

The present invention provides a power generation complementary system for tidal range power generation and construction thereof, which is a system that provides stable power output by setting up a tidal range power generation facility in a bay area that carries out reciprocal and complementary electric power generation corresponding to turning point sections of a high/low tide water level curve.

### (b) Description of the Prior Art

A power generation facility that captures ocean energy uses the potential difference of continuous surges of sea level tides, and is a tidal power generation system that converts an upward and downward swinging mechanical movement to generate electric power. The tidal power generation system uses the tidal range difference between high and low tides to convert into electric power through flow equipment.

Regarding a general tidal power generation system, the change in potential energy is not significant within the limits of the two time sections of the rising tide and falling tide. And the system that continuously generates electric power suffers from two shortcomings which cause the inability to sustain a constant output of electric power.

Referring to FIG. 1, which shows a tidal time curve T/C produced by rising and falling tides, and depending on the geographical environment, depicts the time distribution for the tidal range difference produced by, for example, a tidal range height H of 5 meters, within a twenty-four hour cycle, within which there are sluggish flow time schedules T2 at the upper and lower amplitudes of low tides and high tides. And spaced between sluggish flow time schedules T2 there are corresponding current surge time schedules T1, within which facility receptors will receive significant changes in the quantity of potential energy. Facility receptors, such as generator blades, within the current surge time schedules T1 will produce significant flow driving forces, whereas during the sluggish flow time schedules T2, the facility receptors are unable to produce significant physical energy, and are the time schedules of weak stable power output.

There are two high and low tides in a 24-hour day, and when trying to access continuous power generation around the clock within the tidal time curve T/C cycle, there will be a lack of power in the system during the sluggish flow time schedules T2, and the system cannot output at full capacity, especially at turning point positions of the sluggish flow time schedules T2 at the peaks or lowest points of the tidal time curve T/C, when the system will experience a brief stoppage in power generation.

The present invention provides a power generation complementary system for tidal range power generation and construction thereof, wherein during the sluggish flow time schedules T2 another conversion equipment performs full power generation that complements the system to output stable power, and resolves the problem of an insufficient flow of physical energy during the sluggish flow time schedules T2 of the tidal time curve T/C.

### SUMMARY OF THE INVENTION

A power generation complementary system for tidal range power generation and construction thereof of the present invention provides a bay construction tidal range power generation facility, which is a system able to carry out reciprocal and complementary power generation in response to the changing high and low tide levels at tidal time curve turning points.

The system is constructed with a reserve weir pool facing the direction of incoming ocean tidal energy, wherein the reserve weir pool is divided into a left pool area and a right pool area. The left pool area and the right pool area are respectively equipped with an energy conversion equipment associated therewith, which generates electric power driven by the energy of passing ocean tidal flows. According to the state of a tidal time curve, mutually dependent control devices relay an instruction to sequentially handover operation from one conversion equipment to the other conversion equipment at the appropriate times. When one of the energy conversion equipment is receiving weak flow driving energy, this handover operation is replied upon to hand over operation to the other conversion equipment to carry out complementary power generation to an acceptable standard amount. The main object of the present invention being to significantly maintain a stable power output from the system.

Another object of the present invention is the embodiment of the conversion equipment being equipped with a kinetic energy conversion device, whereby the kinetic energy converted therefrom is transmitted upward during a high tide to an electric generator installed at the height position of the highest high tide level.

A third object of the invention is a control system equipped with flow sensing units, which provide information to flow control devices that direct the operating state of the kinetic energy conversion devices.

A fourth object of the invention is enabling the electric power generated to pass through electrical processing units, after which the electric power is merged and output through a junction unit.

A fifth object of the invention is to equip each of the kinetic energy conversion devices with a drum body, the periphery of which is connected to a culvert drilled in a cofferdam set up in the reserve weir pool area. The interior of the drum body affords passage to a through-flow cylinder, which is axially fitted with a turboprop device.

A sixth object of the invention is to expand one end of the through-flow cylinder facing the ocean to form a catchment cone that guides the ocean current. An outer end of the catchment cone is fitted with a gate control device to change through-flow forces.

A seventh object of the invention is to configure the gate control device with a single flashboard or grid plates comprising multiple plates, which together can be opened and closed.

An eighth objective of the invention is to make the operating angular positions of paddles of the turboprop device adjustable, wherein the maximum angular position of the paddles is able to substitute for the function of the gate control device to seal the through-flow cylinder. During operation, the angular positions of the paddles can further respond to the physical state of the ocean current and actual motive force requirements and be changed accordingly.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a representation diagram of an ideal tidal range time curve.

FIG. 2 is a drawing of an embodiment of a complementary system facility structure of the present invention.

FIG. 3 is a schematic view of the complementary system responding to the ocean current according to the present invention.

FIG. 4 is a schematic view of the complementary system reverse feeding back the ocean according to the present invention.

FIG. 5 is a schematic drawing of a control system of the present invention.

FIG. 6 is an operational schematic view of floodgate switching curves formed by the control system responding to tidal range times according to the present invention.

FIG. 7 is a structural side view of a kinetic energy conversion device of the present invention.

FIG. 8 is another structural side view of the kinetic energy conversion device of the present invention.

FIG. 9 is an overhead schematic view of an embodiment of grid plates of a gate control device of the present invention.

FIG. 10 is an operational front view of the grid plates of the present invention.

FIG. 11 is a schematic view of angular position adjustment of the grid plates of the present invention.

FIG. 12 is a front view of the through-flow state of a through-flow cylinder through adjustment of the grid plates according to the present invention.

FIG. 13 is schematic view of the change in the angular position of a paddle of a turboprop device according to the present invention.

FIG. 14 is a front view of the change in the angular position of the paddles of the turboprop device according to the present invention.

FIG. 15 is a schematic view of another change in the angular position of the paddles of the turboprop device according to the present invention.

FIG. 16 is a front view of another change in the angular position of the paddles of the turboprop device according to the present invention.

FIG. 17 is a schematic view of a mesh fitted on the internal end of an embodiment of a cofferdam corresponding to the through-flow cylinder of the present invention.

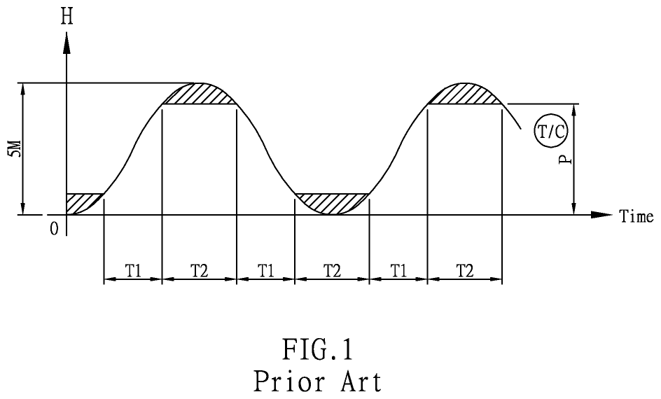

### DETAILED DESCRIPTION OF THE PREFERRED EMBODIMENTS

A power generation complementary system for tidal range power generation and construction thereof of the present invention is a system that provides a bay construction tidal range power generation facility that responds to rising/lowing tides, and carries out reciprocal and complementary power generation when the high and low water levels change at seawater level curve turning points. The system is constructed with a reserve weir pool facing the direction of incoming ocean tidal energy, wherein the reserve weir pool is divided into a left pool area and a right pool area. The left pool area and the right pool are positioned at the lower portion of a cofferdam 11 close to the seabed, and each of the pool areas has a culvert 15 that runs through to the ocean. An energy conversion equipment is installed inside each of the respective culverts 15, wherein the energy conversion equipment generates electric power driven by the energy of passing ocean tidal flows. According to the state of a tidal curve, mutually dependent control devices relay an instruction to sequentially handover operation from one conversion equipment to the other conversion equipment at the appropriate times. This handover operation is relied upon to cause one of the conversion equipment to operate when the tidal driving energy is relatively low, enabling the other conversion equipment to carry out power generation to an executable standard amount, thereby achieving an electric power generation complementary system, which is able to significantly maintain an electrical power stabilization output 24 hours a day.

An embodiment of each of the conversion equipment is equipped with a kinetic energy conversion device, and the kinetic energy converted therefrom is upwardly transmitted through a pathway to an electric generator installed at the height position of the highest high tide water level at high tide. The pathway is a transmission shaft, and a speed variator device is installed between the transmission shaft and the electric generator, to enable adjusting rotational speed of the electric generator. This adjustment facilitates allocating electric output power over unit time, or adjusting the amount received by the electric generator in response to changes in tidal energy.

A control system is configured with a time sequence control unit, which respectively instructs operating times of the left pool area and the right pool area according to a tidal time curve, sequentially handing over operation accordingly. The control system is further equipped with a flow sensing unit, which acquires ocean current flow information that provides operational reference for a flow control device to adjust the corresponding kinetic energy conversion devices.

The normal operating state of the present system uses the time sequence control unit to respectively operate a left conversion equipment and a right conversion equipment associated with the left pool area and the right pool area, respectively, which, according to the changing state of the tidal time curve, allocates handover for complementary electric power generation.

The electric power generated passes through electrical processing units, and then merged and output through a junction unit. Each of the kinetic energy conversion devices is fitted with a drum body, the periphery of which is connected to a culvert drilled in a cofferdam, and the axial interior affords passage to a through-flow cylinder, which is provided with a turboprop device. One end of the through-flow cylinder facing the ocean is expanded to form a catchment cone, the outer end of which is fitted with a gate control device. The gate control device is a flashboard, or a multiple combination of grid plates.

The surface of a pivot body of the turboprop device is equiangularly configured with mounting planes, which enable assembly of paddles thereon. The operating angular positions of the paddles on the turboprop device are adjustable, one extreme of which can be used as a substitute for the function of the gate control device to seal the through-flow cylinder. In addition, angular position settings for the paddles can be further changed in response to the quantity of the ocean current and actual motive force requirements.

The present invention mainly uses the control system to operate the left conversion equipment and the right conversion equipment in response to operating times of the tidal time curve. When the operating energy of one of the conversion equipment becomes weak, operation is handed over to the other conversion equipment to carry out electric power generation, and uses electric power generation time scheduling handover complementation to maintain stable systematic power output. Regarding the system of the present invention and operating state thereof, please refer to the description of the diagrams as follows.

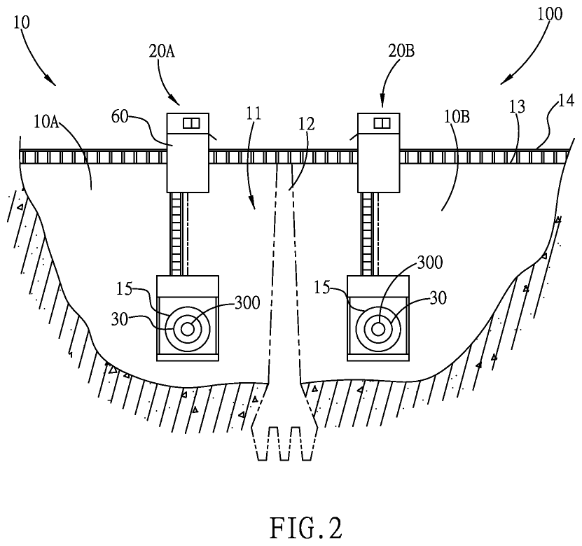

Referring first to FIG. 2, which shows a complementary system 100 set up in a bay or any ocean front suitable for operation, wherein a large-scale cofferdam 11 is installed, and uses an inland barrier to set up a reserve weir pool 10. A partition portion 12 is further installed in the center of the reserve weir pool 10 to partition the reserve weir pool 10 into a left pool area 10A and a right pool area 10B, which are respectively positioned at the lower portion of the cofferdam 11 close to the seabed, and each of the pool areas is provided with the culvert 15 that runs through to the ocean. A left conversion equipment 20A and a right conversion equipment 20B is installed inside each of the respective culverts 15. A side embankment of the cofferdam 11 can be used as a roadway 13 for transportation, with the roadway 13 structured with a guard rail 14. The entire construction area can be greened to match the natural environment or landscaped for recreational purposes, or further equipped as an area for school children to experience science up close.

The left conversion equipment 20A and the right conversion equipment 20B of the system are each equipped with a kinetic energy conversion device 30 and an electric generator 60, wherein the kinetic energy conversion devices 30 are installed in the cofferdam 11 where the culverts 15 are positioned close to the seabed. The electric power generated is transmitted through to the electric generator 60 positioned at the highest water level at high tide. The electric generators 60 are located close to the roadway 13 to facilitate maintenance thereof and prevent seawater erosion. An internal shaft of each of the kinetic energy conversion devices 30 is fitted with a turboprop device 300.

The above-described reserve weir pool 10 is divided into the left pool area 10A and the right pool area 10B by the partition portion 12 to facilitate application in a single bay.

If there are two adjacent bays in the geographical environment, then a separating roadway is used as the partition portion 12, whereby the two bays are separately designated as the left pool area 10A and the right pool area 10B.

Further, the description of the divided pool areas being designated as left and right is merely to facilitate explanation, and does not limit orientation of the pool areas in a geographical direction.

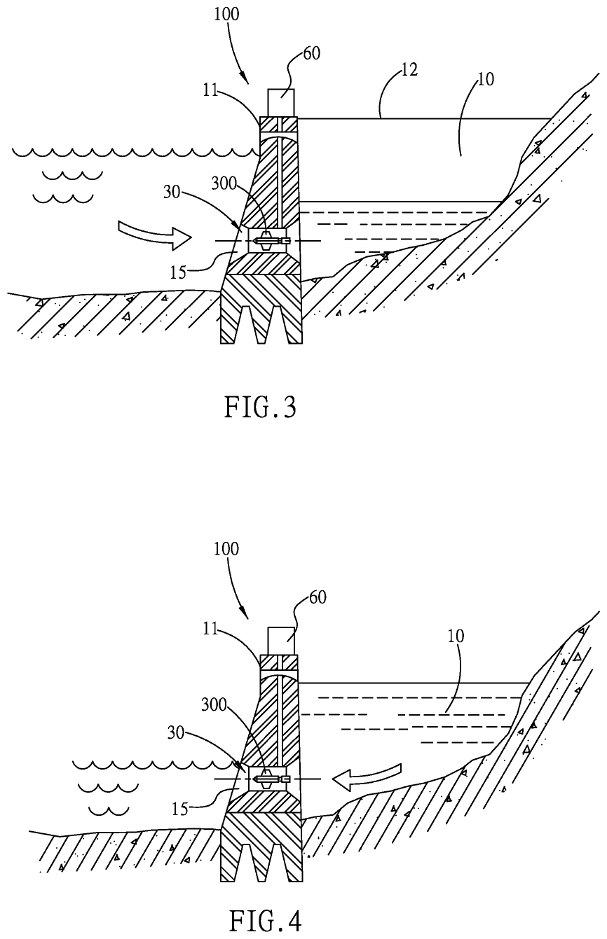

Referring to FIG. 3, which shows the kinetic energy conversion device 30 installed in the complementary system 100, wherein the incoming ocean tide enters the reserve weir pool 10 during the process of receiving the rising ocean tide, whereupon the turboprop device 300 receives the dynamic flow energy of the ocean tide, which is converted to rotational energy that drives the electric generator 60.

Referring to FIG. 4, when the falling tide is approaching low tide, the kinetic energy conversion device 30 installed in the complementary system 100 receives the dynamic flow from the reserve weir pool 10 and returns it to the ocean. This process drives operation of the turboprop device 300, with the energy produced therefrom being transmitted to the high-positioned electric generator 60, providing the basis for the electric generator 60 to generate electric power.

As shown in FIG. 2, the basic principle of the above description applies to both the left conversion equipment 20A and the right conversion equipment 20B, which are each equipped with the corresponding kinetic energy conversion device 30. However, the system further needs to be controlled, which is described hereinafter.

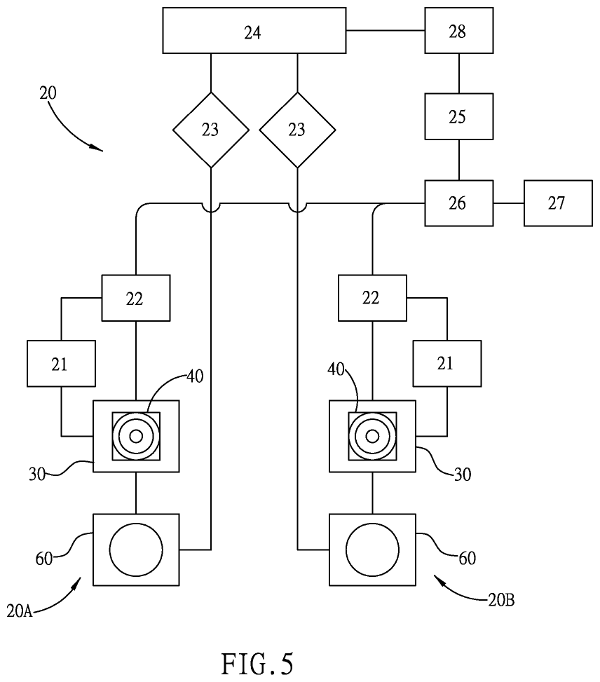

Referring to FIG. 5 (in conjunction with FIG. 2), the mechanical rotational energy produced by the kinetic energy conversion devices 30 are indirectly transmitted to the respective electric generators 60, and is the basis for the electric generators 60 to generate electric power. The left conversion equipment 20A and the right conversion equipment 20B are each fitted with a flow sensing unit 21 and a flow control device 22, which are controlled by a time sequence control unit 26 installed in a control system 20, wherein the flow sensing units 21 sense the physical state of the tidal current, such as flow rate or pressure, and the information received is transmitted to the respective flow control device 22, which accordingly adjusts the operating state of the corresponding kinetic energy conversion device 30, and mainly refers to the operating state of gate control devices 40 that depend on the quantity of ocean water, or are adjusted according to a tidal range curve.

The electric power generated by the electric generators 60 is respectively processed by an electrical processing unit 23, merged by a junction unit 24 and then transmitted to a supply end 28. The electric power at the supply end 28 further branches to supply an electric storage unit 25 of the control system 20, wherein the electric storage unit 25 provides the time sequence control unit 26 with electric power to operate. The time sequence control unit 26 also monitors the left conversion equipment 20A and the right conversion equipment 20B, and is additionally fitted with a water level detection unit 27 that detects tidal range heights, the information from which directly provides the time sequence control unit 26 a basis for calculating required parameters for the control system 20.

The respective operating times of the left conversion equipment 20A and the right conversion equipment 20B of the above-described control system 20 are in accordance with the actual state of the rising/falling tides, or parameters can be manually set for sampling to serve as programme parameters.

Two threshold curve sections at low tide and high tide are used for basic system control, wherein the time sequence control unit 26 instructs one of the pool areas 10A, 10B to carry out power generation operations, while the other pool area is in a standby state.

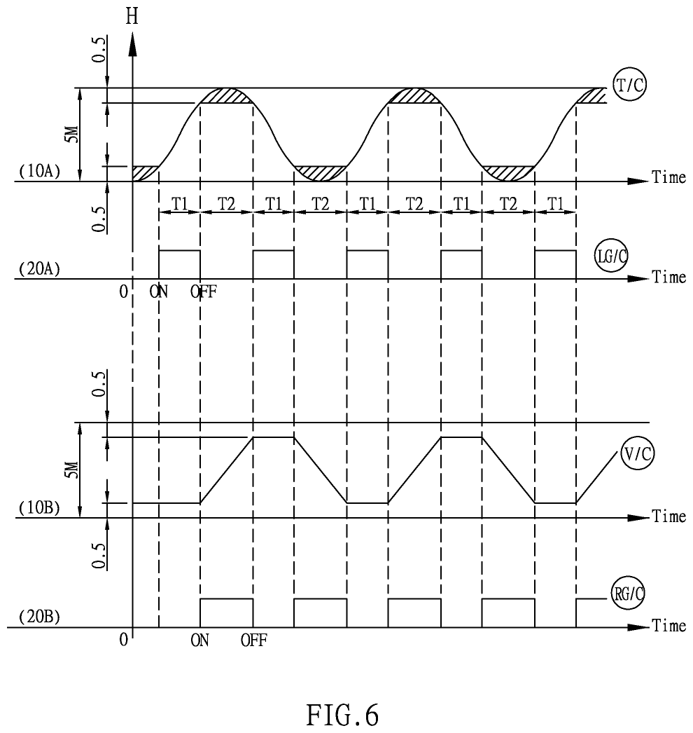

Referring to FIG. 6 (which shows high and low curve inflections of a tidal time curve T/C and rising/falling tidal range heights), wherein the controlling operating state of the control system 20 produces the tidal time curve T/C, which shows the fluctuating curve of a normal rising/falling tide cycle. For example, if the height difference of the curve is 5 meters, a floodgate switching curve LG/C is distributed corresponding to the times of the tidal time curve T/C that enables operation of the left conversion equipment 20A; and a floodgate switching curve RG/C enables the opening and closing operation of the right conversion equipment 20B according to a volume curve V/C of the seawater storage volume change.

The tidal time curve T/C changes according to the time schedules described above, and entry and exit time schedule intervals form fore and after consecutive current surge time schedules T1 and sluggish flow time schedules T2. The left conversion equipment 20A and the right conversion equipment 20B produce floodgate switching curves for different operating times corresponding to the current surge time schedules T1 and the sluggish flow time schedules T2 (in order to describe the fore and after corresponding relationship, FIG. 6 is divided into an upper and lower part, wherein the current surge time schedules T1 and the sluggish flow time schedules T2 are segmented according to the tidal time curve T/C, with dotted lines directed downward to indicate their relationship to the left conversion equipment 20A and the right conversion equipment 20B. The changes in flow potential energy of the left pool area 10A and the right pool area 10B being first explained).

During the natural rise/fall of the ocean, the tidal time curve T/C shows formation of the current surge time schedules T1 with a relatively large flow energy and the sluggish flow time schedules T2 with a weak energy force, wherein the time-interval curves during the sluggish flow time schedules T2 reach the rising/falling transition thresholds, where flow energy cannot be produced at these points.

The current surge time schedules T1 and the sluggish flow time schedules T2 are alternating consecutive states, and serve as benchmarks for how the system operates, wherein the floodgate switching curve LG/C for the left conversion equipment 20A turns on the floodgate switching curve of the gate control device 40 associated therewith, and the floodgate switch for the right conversion equipment 20B is in correspondence with the floodgate switching curve RG/C.

Regarding the corresponding operating states of the above two curves, when the floodgate switching curve LG/C of the left conversion equipment 20A is in an open time schedule, the floodgate switching curve RG/C of the right conversion equipment 20B is in a closed time schedule. The opening and closing actions of the two are continuously alternating.

In addition, the above-described alternating time schedules can be correspondingly time advanced or time delayed, whereby adjustment of the time schedules can ready one of the equipment to take over operation. And during a stationary state, the static friction effect of the mechanism is overcome, so that sufficient electric power can be generated at the threshold time sections when handing over power generation.

The basic control requirements are that the floodgate switching curve RG/C corresponding to the right conversion equipment 20B marks the opening and closing time points of the gate control device 40 associated therewith, with the opening and closing time points marked on the floodgate switching curve LG/C corresponding to the left conversion equipment 20A indicating opposite operating time sequences, that is, when the right conversion equipment 20B is operating, the left conversion equipment 20A is shut down, and vice versa.

Referring together with the drawing shown in FIG. 2, according to the changes in tidal currents, corresponding operating times of the left conversion equipment 20A and the right conversion equipment 20B are the handover time points described above. The kinetic energy conversion device 30 of the left pool area 10A is operated by the time sequence control unit 26 according to the programmed floodgate switching curve LG/C, and is open during the current surge time schedules T1 at high tide periods, enabling the ocean current to enter the left pool area 10A. Before the left pool area 10A is full, a height is set, for example, 4.5 meters, as the starting point for the sluggish flow time schedule T2, whereupon the kinetic energy conversion device 30 of the left pool area 10A is shut down during this sluggish flow time schedule T2, within which time the interior of the left pool area 10A has a full storage of water. In addition, at the starting point of the sluggish flow time schedule T2, the kinetic energy conversion device 30 of the right pool area 10B is simultaneously switched on (that is, initiation of the floodgate switching curve RG/C associated therewith), causing the water level of the rising tide during the sluggish flow time schedule T2 to enter the still empty right pool area 10B. When the sluggish flow time schedule T2 has come to an end, the floodgate of the left conversion equipment 20A is once again opened, and the kinetic energy conversion device 30 associated therewith is switched on while simultaneously closing the flow path to the right conversion equipment 20B. Whereupon, because the flow path to the left pool area 10A was previously closed, causing the accumulated seawater level to be higher than the height of the ocean water level, potential energy is released as the seawater level falls, with the kinetic energy conversion device 30 using this potential energy to carry out energy conversion. When time has advanced to the second current surge time schedule T1, because of its previous closure, the right pool area 10B has a high water level storage. When the time for closing the left conversion equipment 20A has arrived according to the second current surge time schedule T1, the floodgate of the kinetic energy conversion device 30 of the right pool area 10B is simultaneously opened, whereupon the kinetic energy conversion device 30 of the right pool area 10B is then subjected to the motive force of the seawater feedback flow to the ocean and generates electric power. That is, when time has advanced to the second current surge time schedule T1 of the left conversion equipment 20A, the kinetic energy conversion device 30 in the left pool area 10A is switched on, and the kinetic energy conversion device 30 of the right pool area 10B is simultaneously shut down, enabling the rising tidal flow to pass through the kinetic energy conversion device 30 and enter the left pool area 10A, thereby achieving a handover start/stop exchange operation.

The above-described operating state is based on the fore and after successive distribution of the current surge time schedules T1 and the sluggish flow time schedules T2, the kinetic energy conversion devices 30 respectively associated with the left conversion equipment 20A and the right conversion equipment 20B being directed by the corresponding time schedule changes of the floodgate switching curve LG/C and the floodgate switching curve RG/C. Hence, staggering the times for switching on/shutting down the two kinetic energy conversion devices 30 enables obtaining the weak energy portions of the sluggish flow time schedules T2 at the different times between the rising tide and falling tide, alternately operating to carry out stable power generation, thus achieving the object of the system to channel out stable power output.

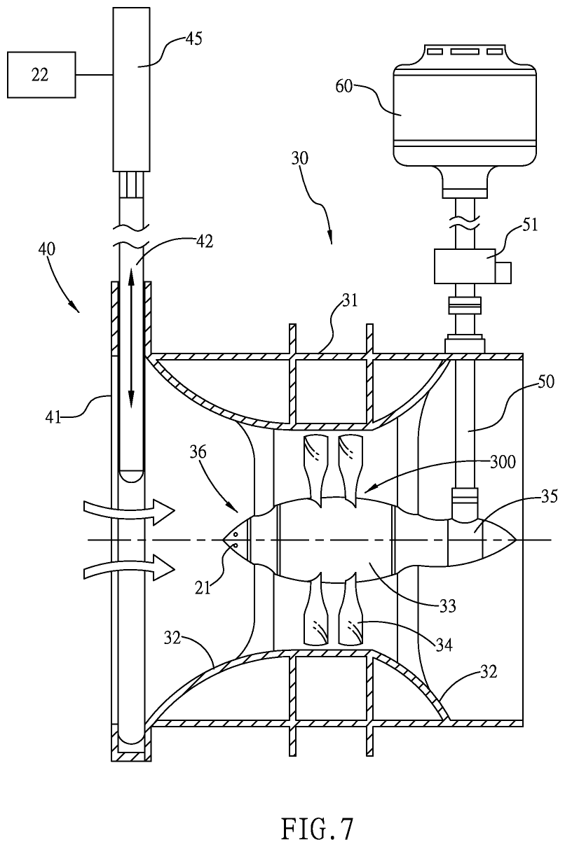

Referring to FIG. 7. which shows the kinetic energy conversion device 30 fitted with a drum body 31, the peripheral surrounding body of the drum body 31 is enclosed by the culvert 15. The center of the drum body 31 is connected from front to back with a through-flow cylinder 36. The interior of the through-flow cylinder 36 enables the turboprop device 300 to be installed therein. The two peripheral ends of the through-flow cylinder 36 are respectively outwardly expanded to form catchment cones 32, which are able to increase the water flow rate to the turboprop device 300. Moreover, using the expanded form of the catchment cones 32 enables drawing in and receiving multi-angular tidal current flow vectors. Moreover, as the tidal force flows through the turboprop device 300, the rotary power converted by the turboprop device 300 is reversed by passing through a reversing device 35, and is then upwardly transmitted through a transmission shaft 50 to the electric generator 60 positioned at the highest potential energy to generate electricity. The transmission shaft 50 is indirectly installed with a speed variator device 51, which enables adjusting the output operating rotational speed in response to requirements of the power generating equipment.

One end of the through-flow cylinder 36 facing the ocean is fitted with the gate control device 40, which controls opening and closing of a floodgate. The gate control device 40 is an insert frame 41 connected to the outer end of the through-flow cylinder 36, and functions to intercept the tidal flow through a flashboard 42. The flashboard 42 is driven by a drive unit 45, which is controlled by the flow control device 22, and raising and lowering of the flashboard 42 achieves the opening and closing operation of the through-flow cylinder 36. Under normal weather conditions, the flashboard 42 can be opened to the full extent, whereas, under conditions whereby the tidal force is relatively large, the flashboard 42 can be half-opened, thereby providing the function to allow applicable quantities of ocean water to pass through the turboprop device 300, preventing fluctuating impact thereon and maintaining stable operation of the turboprop device 300.

The electric generators 60 are positioned in the space above the highest water level of the high tide (as shown in FIG. 2), or can be installed in the physical space connected by road, to facilitate maintenance. The speed variators device 51 are similarly respectively installed close to the electric generators 60.

One end of each of the turboprop devices 300 of the through-flow cylinders 36 facing the ocean is centrally fitted with the flow sensing unit 21 as part of the control system 20, to enable accurate detection of changes in the quantity of tidal ocean water passing through the through-flow cylinder 36.

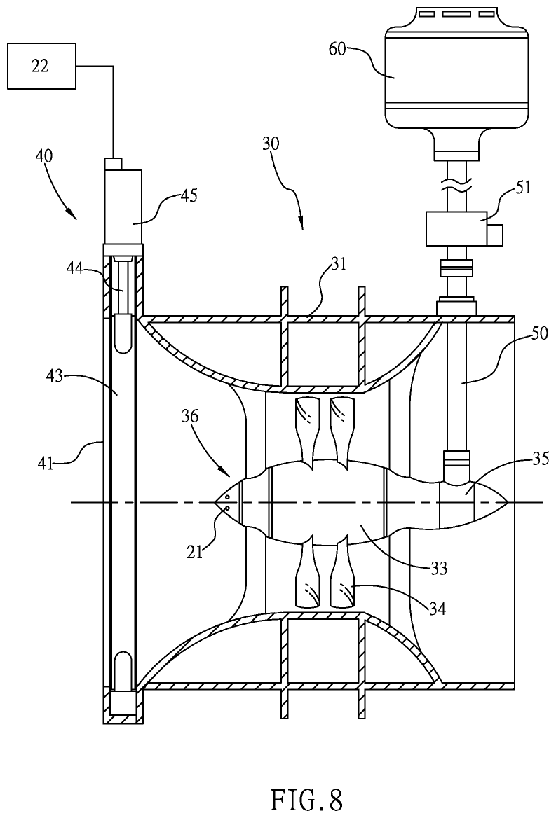

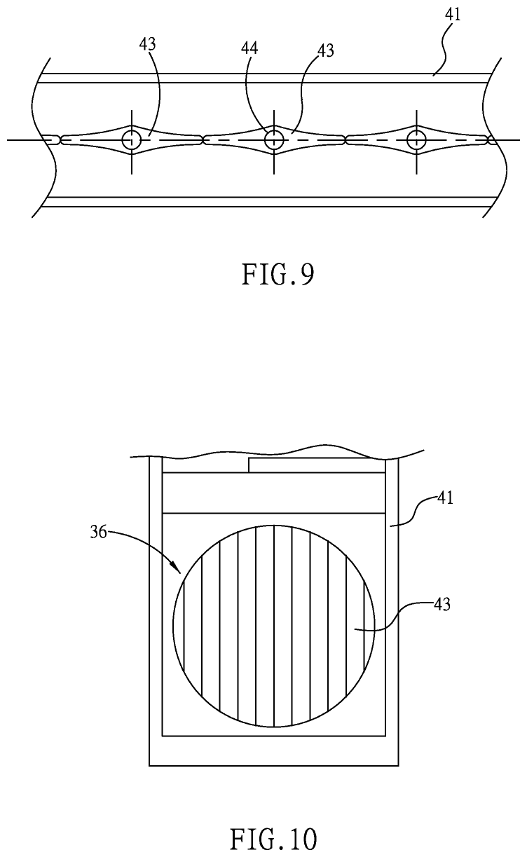

Referring to FIGS. 8 and 9, as described above, one end of the through-flow cylinder 36 of the kinetic energy conversion device 30 facing the ocean is equipped with the gate control device 40, which is structured to comprise a plurality of parallel paddles 34, drive shafts 44 that are driven by the drive unit 45, and grid plates 43 that are angularly adjusted by the drive shafts 44 driven by the drive unit 45, wherein the drive unit 45 is controlled by the flow control device 22 (as shown in FIG. 5). When the grid plates 43 are adjusted to a maximum angular-positioned closed state, as shown in the overhead view of FIG. 9, the edges of the corresponding adjacent grid plates 43 are aligned. That is, a continuous screen-grid is formed after the drive unit 45 drives the drive shafts 44 to cause the edges of each of the corresponding adjacent grid plates 43 to be aligned (as shown in FIG. 10), which is entirely effected at the outer end of the through-flow cylinder 36. FIG. 9 shows the state of the grid plates 43 positioned inside the insert frame 41, creating the function of a planar screen-grid, which enables blocking ocean currents from entering the through-flow cylinder 36.

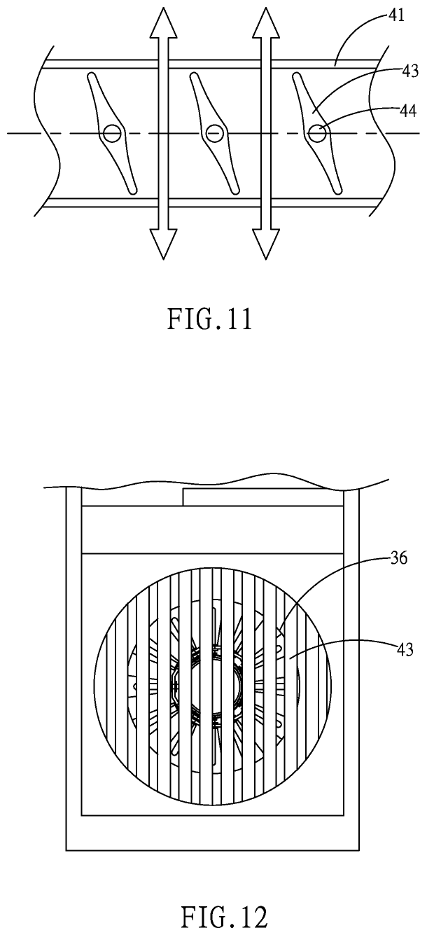

Referring to FIG. 11, which shows the grid plates 43 rotated by the drive shafts 44, wherein the angular position of the grid plates 43 can be set to be half-open or fully open, thereby enabling the through-flow cylinder 36 to have the function of allowing half flow-through or full flow-through of the ocean currents, respectively.

Under day-to-day weather conditions, the operating states of the grid plates 43 are mainly fully open or fully closed. In a half-open state (as shown in FIG. 12), clearances have been flipped open between the corresponding adjacent grid plates 43 to form pathways for the ocean current.

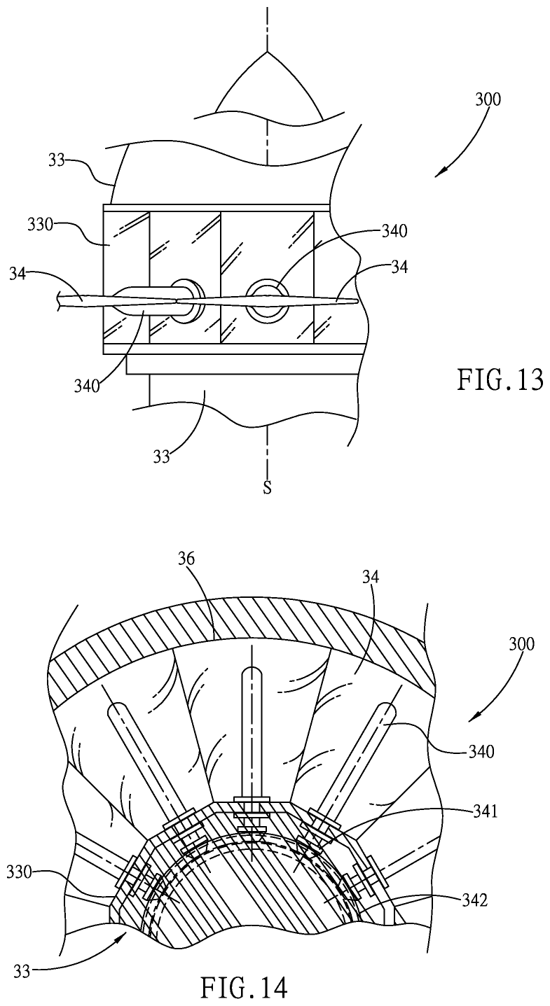

Referring to FIGS. 13 and 14, which show that the operating angular positions of the paddles 34 fitted to the turboprop device 300 are adjustable, wherein one angular position is either completely closed or completely open, which functions as a replacement for opening and closing of pathways to the through-flow cylinder 36. Other operating angular positions are half-open or fully open to enable the ocean currents to half flow-through or fully flow-through, respectively. The motive force of radial axes 340 is transmitted to the paddles 34 to enable changing the angular position thereof. A plurality of mounting planes 330 are respectively equiangularly fitted to the periphery of a pivot body 33, wherein the mounting planes 330 enable the radial axes 340 to respectively penetrate and be mounted therein. Each of the radial axes 340 connectively drives the corresponding paddle 34.

Referring to FIG. 14, which shows the pivot body 33 equiangularly distributed with the mounting planes 330, with the radial axes 340 radially perpendicular and movable pivoted on the mounting planes 330. A gear wheel 341 is fitted inside each of the radial axes 340, wherein a fluted disc 342 meshes with the gear wheels 341, thereby indirectly enabling radial rotation of the radial axes 340, which drives angular flipping of the paddles 34. The state shown in FIG. 14 is based on the configuration shown in FIG. 13, wherein the side edges of the adjacent paddles 34 are flush with each other, and the outer edges of the paddles 34 are flush with the inner surface of the through-flow cylinder 36, thereby forming the function to screen the through-flow cylinder 36.

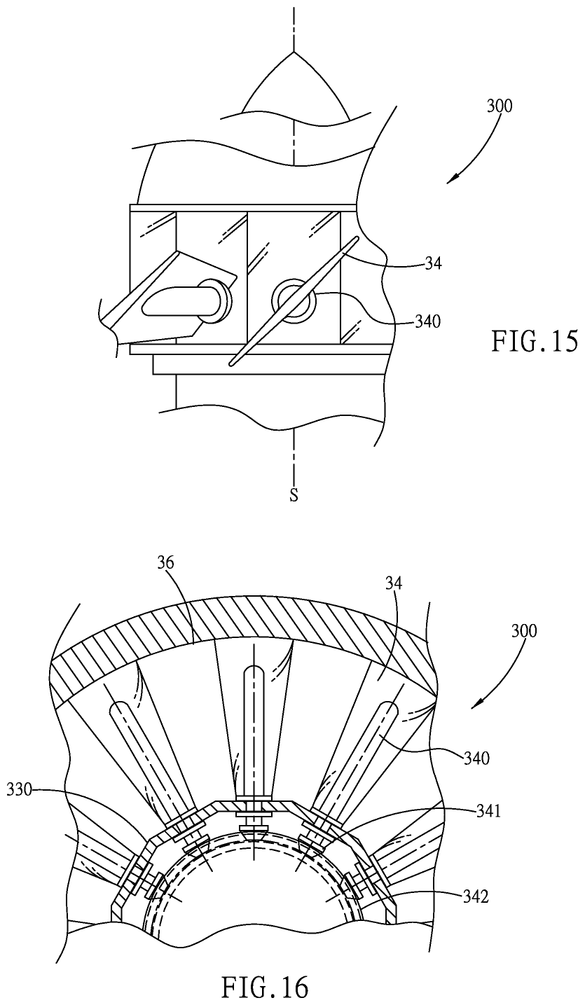

Referring to FIG. 15, which shows an angular position change in the paddles 34 by means of the radial axes 340, as described above, wherein the angular position of paddles 34 can be fully open or half-open.

Referring to FIG. 16, which shows the paddles 34 in a half-open state, wherein diagonal clearance pathways between the paddles 34 are opened up to allow passage to the through-flow cylinder 36, thereby enabling the ocean current to flow through the through-flow cylinder 36.

Because the paddles 34 are angularly adjusted by the radial axes 340, angular position of the paddles 34 can be accordingly adjusted corresponding to changes in quantity of ocean water. Effecting such adjustment is achieved by using the flow sensing unit 21, shown in FIG. 5, which is instructed to operate through the flow control device 22. The flow control device 22 in the control system 20 drives the fluted disc 342 through any electromechanical means to mesh with the gear wheels 341 and achieve radially displacement adjustment. Accordingly, the system of paddles 34 serves as a functional replacement to seal the through-flow cylinder 36.

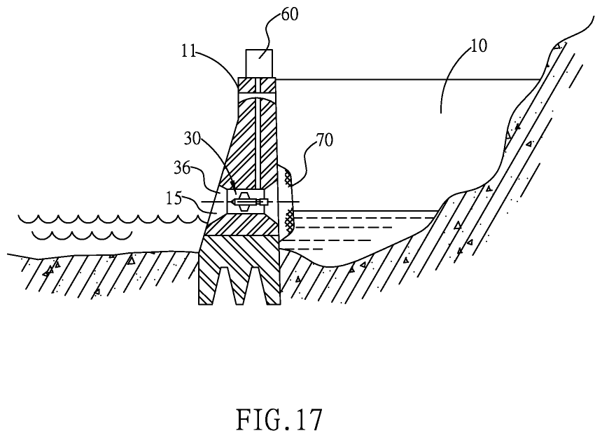

Referring to FIG. 17, which shows the through-flow cylinder 36 positioned at the internal end opening of the reserve weir pool 10, wherein a mesh 70 able to block fish from passing through is fitted as a grid corresponding to and surrounding the through-flow cylinder 36. The reserve weir pool 10 retains a lowest water level to provide a volume of seawater for fish to move around in, which can be used to artificially cultivate sea fish.

The complementary system provided by the present invention mainly uses a cofferdam and a partition portion constructed in a bay, and separates out a left pool area and a right pool area, wherein the left pool area and the right pool area are respectively installed with a corresponding left conversion equipment and right conversion equipment. Operating times of kinetic energy conversion devices respectively associated with the left conversion equipment and the right conversion equipment are controlled by a control system. In response to current surge time schedules and sluggish flow time schedules of a tidal time curve, subsequent time adjustments are made to carry out complementary operations, enabling operating times of the respective kinetic energy conversion device associated with the left pool area and the right pool area to reciprocally compensate sluggish flow time schedule portions of the tidal time curve. Stable power output from the system is the main object and problem resolved by the present invention. Compared with facilities of the prior art, the present invention is a completely new concept that provides an innovative invention for a system that outputs stable power. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A power generation complementary system for tidal range power generation and construction thereof, which provides a bay construction tidal range power generation facility, which is a system able to carry out reciprocal and complementary power generation in response to changing high and low tide levels at tidal time curve turning points, comprising:
a reserve weir pool facing the ocean surrounded by a cofferdam, the reserve weir pool is divided into a left pool area and a right pool area;
the left pool area and the right pool area are respectively equipped with a culvert that runs through to the ocean and is positioned at a lower portion of the cofferdam close to the seabed;
a left conversion equipment is installed in the left pool area and a right conversion equipment is installed in the right pool area, the left conversion equipment and the right conversion equipment are respectively fitted with a kinetic energy conversion device axially assembled to the culvert, an interior of each of the kinetic energy conversion devices is equipped with a turboprop device, and the rotary power converted by the turboprop device is upwardly transmitted to a corresponding electric generator;
a control system, which is configured with a time sequence control unit, which directly hands over operating times to the two corresponding conversion equipment to carry out complementary power generation according to current surge time schedules and sluggish flow time schedules marked on the changing state of a tidal time curve.

2. The power generation complementary system for tidal range power generation according to claim 1, wherein the control system respectively controls handover of operating times to the left conversion equipment and the right conversion equipment, handover to the left conversion equipment and the right conversion equipment effects reciprocal opening/closing of the seawater flow paths to the respective kinetic energy conversion device, and determines whether the conversion equipment generates electric power, as well as controlling the water level of the respective pool area.

3. The power generation complementary system for tidal range power generation according to claim 1, wherein one end of each of the kinetic energy conversion devices facing the ocean is configured with a catchment cone.

4. The power generation complementary system for tidal range power generation according to claim 1, wherein one end of each of the kinetic energy conversion devices facing the ocean is fitted with a grid control device.

5. The power generation complementary system for tidal range power generation according to claim 4, wherein the grid control device is provided with an insert frame assembled to one end of the kinetic energy conversion device, and a drive unit assembled at the top end of the insert frame, a drive shaft downward drives multiple parallel grid plates, the angular position of which is variable to change the open/closed state of the pathway to a through-flow cylinder.

6. The power generation complementary system for tidal range power generation according to claim 1, wherein a pivot body of the turboprop device is cylindrical, which provides paddles to be assembled thereon, angular position of the surfaces of the paddles is variable through adjustable turning of radial axes fitted to a fluted disc.

7. The power generation complementary system for tidal range power generation according to claim 1, wherein the control system configured with the time sequence control unit diverts operation to a flow sensing unit and a flow control device respectively associated with the left conversion equipment or the right conversion equipment, wherein the flow control device controls the opening/closing of the pathway to the respective kinetic energy conversion device, enabling the ocean current to flow therethrough, and a water level detection unit provides additional data to the time sequence control unit as a basis for calculating required operating parameters for the control system.

8. The power generation complementary system for tidal range power generation according to claim 1, wherein the control system, according to multiple fore and after successive current surge time schedules and sluggish flow time schedules marked out on a tidal time curve, instructs the left conversion equipment within the current surge time schedules to open the flow path to the respective kinetic energy conversion device, during which times the kinetic energy conversion device of the right conversion equipment is shut down; the left conversion equipment within the sluggish flow time schedules is shut down stopping the flow path to the respective kinetic energy conversion device, and the flow path to the kinetic energy conversion device of the right conversion equipment is opened, thereby bringing about successive handover operating times to the left conversion equipment and the right conversion equipment according to the changing tidal time curve, to enable complementary operation therebetween.

9. A construction method for the power generation complementary system for tidal range power generation, whereby a tidal power generation complementary system facility is constructed in a bay, which responds to the changes in high and low water levels of rising/falling tides, and carries out reciprocal and complementary power generation at tidal curve turning points, comprising steps of:
a) selecting a bay landscape, wherein a large gate facing the ocean is set up with a cofferdam enclosing a reserve weir pool, which is divided into a left pool area and a right pool area;
b) installing respectively a left conversion equipment and a right conversion equipment in the left pool area and the right pool area, wherein each conversion equipment is equipped with a kinetic energy conversion device and an electric generator, the kinetic energy conversion devices are installed at the lower portion of the cofferdam close to the seabed, and the electric generator is installed at a position higher than the water level position at high tide;
c) fitting a control system, wherein a time sequence control unit controls operating times of the left conversion equipment and the right conversion equipment, and complementary handover operations are carried out according to current surge time schedules and sluggish flow time schedules marked on a tidal time curve, at threshold curve sections at low tide and high tide, the time sequence control unit directs one of the pool areas to carry out power generation operations, while the other pool area is in a standby state.

10. The construction method for the power generation complementary system for tidal range power generation according to claim 9, wherein each of the kinetic energy conversion devices is equipped with a through-flow cylinder, which is axially fitted with a turboprop device, opening and closing of the through-flow cylinder is the basis for carrying out power generation, and the flow path through the through-flow cylinder is controlled by a flow control device of the control system.

11. The construction method for the power generation complementary system for tidal range power generation according to claim 10, wherein operating times of the flow control device is controlled by the time sequence control unit, and operating instructions for the time sequence control unit are obtained from a flow sensing unit/water level detection unit.
